(19) United States
(12) Patent Application Publication
(10) Pub. No.: US 2012/0287201 A1
(43) Pub. Date: Nov. 15, 2012

(54) PROCESS FOR PREPARING A DISPERSION OF A PARTICULATE SOLID

(76) Inventors: Owen Roger Lozman, Blackley (GB); Richard Thomas Williams, Blackley (GB)

(21) Appl. No.: 13/513,032

(22) PCT Filed: Nov. 8, 2010
(86) PCT No.: PCT/GB10/51854

§ 371 Date: May 31, 2012

(30) Foreign Application Priority Data
Dec. 1, 2009 (GB) 0921009.7

(51) Int. Cl. B41J 2/015; B41J 2/175; C09D 11/10; C08K 5/053; C08L 33/10

(52) U.S. Cl. 347/20; 524/388; 347/86

(57) ABSTRACT

A process for preparing a dispersion of a particulate solid is described, which comprises dispersing a particulate solid with a dispersant and a liquid medium, wherein the dispersant is a random copolymer obtained from the copolymerisation of a composition comprising: i) optionally one or more monoethylenically unsaturated hydrophilic monomers, ii) one or more monoethylenically unsaturated hydrophobic monomers, iii) one or more di- and/or higher-ethylenically unsaturated monomers, and iv) one or more chain transfer agents wherein at least one of the chain transfer agents has one or more hydrophilic anionic groups.

### TECHNICAL FIELD

This invention relates to a process for preparing a dispersion of a particulate solid and to encapsulated particulate solids obtainable by the process. It also relates to inks containing said encapsulated particulate solids.

### BACKGROUND

WO 2006/064193 describes a process for providing dispersed pigments suitable for use in ink jet printing inks. The pigments are coated with a random copolymer dispersant derived from monoethylenically unsaturated monomers. These dispersants have a linear structure. The dispersant is then cross-linked around the pigment. While this process provides pigment dispersions with useful properties, there is a continuous need to improve the technology. In particular, there is a desire to provide prints with improved durability, particularly on glossy media. Furthermore the prints desirably have the best possible optical density especially when printed onto plain paper. It is also desirable to find dispersants which facilitate easy milling of pigments to prepare dispersions of particles having a submicron average particle size. Such dispersions are also desirably stable with respect to storage or use. The present invention attempts to solve, at least in part, one or more of the abovementioned problems.

### SUMMARY OF THE INVENTION

According to a first aspect of the present invention there is provided a process for preparing a dispersion of a particulate solid comprising:

dispersing a particulate solid with a dispersant and a liquid medium,
wherein the dispersant is a random copolymer obtained or obtainable from the copolymerisation of a composition comprising:
i) optionally one or more monoethylenically unsaturated hydrophilic monomers,
ii) one or more monoethylenically unsaturated hydrophobic monomers,
iii) one or more di- and/or higher-ethylenically unsaturated monomers, and
iv) one or more chain transfer agents wherein at least one of the chain transfer agents has one or more hydrophilic groups;
   wherein the dispersion step is effected by a mechanical treatment which reduces the particle size of the particulate solid; and with the proviso that when:
A) the dispersant copolymerisation composition comprises one or more monoethylenically unsaturated hydrophilic monomers as component i); and
B) any of the chain transfer agent(s) in component iv) is 3-mercaptopropionic acid, acrolein or methacrolein;
   then in that case the ratio of the total hydrophilic groups in all of the one or more monoethylenically unsaturated hydrophilic monomers of component i) expressed in moles to the total amount of hydrophilic groups in all the chain transfer agents of component iv) expressed in moles is less than 5:1.

Preferably, when conditions A) and B) are met the proviso in the first aspect of the present invention requires a ratio of the total hydrophilic groups in all of the one or more monoethylenically unsaturated hydrophilic monomers of component i) expressed in moles to the total amount of hydrophilic groups in all the chain transfer agents of component iv) expressed in moles is less than 3:1, preferably less than 1:1, especially less than 0.3:1 and most especially less than 0.1:1.

### DETAILED DESCRIPTION

### Particulate Solid

The particulate solid is preferably an inorganic or organic particulate solid or a mixture thereof which is insoluble in the liquid medium.

Examples of suitable particulate solids include inorganic and organic pigments; extenders and fillers for paints and plastics materials; disperse dyes and water-soluble dyes in liquid media which do not dissolve said dyes; optical brightening agents; textile auxiliaries for solvent dyebaths, inks and other solvent application system; particulate ceramic materials; magnetic particles (e.g. for use in magnetic recording media); biocides; agrochemicals; and pharmaceuticals.

Preferably, the particulate solid is a colorant which is insoluble in the liquid medium, more preferably a pigment.

Preferably, the pigment is a carbon black or an organic pigment.

A preferred particulate pigment is an organic pigment, for example any of the classes of pigments described in the Third Edition of the Colour Index (1971) and subsequent revisions of, and supplements thereto, under the chapter headed “Pigments”. Examples of organic pigments are those from the azo (including disazo and condensed azo), thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes.

Preferred organic pigments are phthalocyanines, especially copper phthalocyanine pigments, azo pigments, indanthrones, anthanthrones and quinacridones.

Preferred inorganic particulate solids include: extenders and fillers, e.g. talc, kaolin, silica, barytes and chalk; particulate ceramic materials, e.g. alumina, silica, zirconia, titania, silicon nitride, boron nitride, silicon carbide, boron carbide, mixed silicon-aluminium nitrides and metal titanates; particulate magnetic materials e.g. magnetic oxides of transition metals, especially iron and chromium, e.g. gamma-Fe₂O₃, Fe₃O₄, and cobalt-doped iron oxides, calcium oxide, ferrites, especially barium ferrites; and metal particles, especially metallic iron, nickel, cobalt and alloys thereof; and carbon blacks. A particularly preferred inorganic particulate solid is carbon black. Gas blacks are especially preferred.

Where the process of the present invention is used to make particulate solid dispersions for use in inks, for example ink jet printing inks, the pigment is preferably a cyan, magenta, yellow or black pigment. The particulate solid may be a single chemical species or a mixture comprising two or more chemical species (e.g. a mixture comprising two or more different pigments which may be of the same or different colours). In other words, two or more different particulate solids may be used in the process of the present invention.

The pigment is preferably not surface treated so as to have dispersing groups covalently bonding to its surface. Preferably, the pigment is not dispersible in the liquid medium (especially water) without the aid of a dispersant.

Preferably, prior to any mechanical treatment the particulate solid has a volume averaged particle size of 1 micron or more, for example from 1 to 100 microns.

### Dispersant

The dispersant used in the process of the present invention may be prepared by copolymerising the composition as defined in the first aspect of the present invention. Equally, however, it may be possible to obtain a previously prepared copolymer containing the required composition from a commercially available source. In this way the present claims do not necessarily require a step in which the components i) to iv) are copolymerised (e.g. by free radical solution copolymerisation) to prepare the dispersant. All that is required is that such a copolymer be used in the process regardless of how it was made or who made it.

The dispersant is preferably prepared by a process in which the components i) to iv) as defined in the first aspect of the present invention are copolymerised.

### Component i)

When present the monoethylenically unsaturated hydrophilic monomers may be all of the same chemical formula or they may comprise two or more (e.g. two to ten) different monoethylenically unsaturated hydrophilic monomers.

The monoethylenically unsaturated hydrophilic monomers typically have one or more, preferably from 1 to 3 hydrophilic groups. Examples of hydrophilic groups include phenolic, sulphonic acid, sulphuric, phosphonic, polyphosphoric, phosphoric acid, carboxylic acid groups, quaternary ammonium, benzalkonium, guanidine, biguanidine and pyridinium which may be in the free acid or salt form, glucoside, saccharide, pyrrolidone, acrylamide hydroxy and poly(ethyleneoxide) groups. Of these preferred hydrophilic groups include sulfonic, phosphonic and especially carboxylic acid groups.

Preferably, the one or more monoethylenically unsaturated hydrophilic monomers each have a solubility in water of greater than 50 g/L. For the solubility test the water is preferably de-ionized water. Preferably, the solubility is measured at 25° C. and a pH of 8. To obtain a pH of 8 KOH is preferably used as a base.

Preferred monoethylenically unsaturated hydrophilic monomers each have a Log P value of less than 1.

Log P is the logarithm (base 10) of the partitioning co-efficient of a substance between n-octanol and water as, for example, described in L. G. Danielsson and Y. H. Zhang, Trends in Anal. Chem, 1996, 15, 188. High Log P values signify hydrophobic compounds (e.g. Styrene has Log P value of approximately 3). Low Log P values signify hydrophilic compounds (e.g. Acrylic acid has a Log P value of approximately 0). Log P value can be experimentally determined. Log P values can be calculated which are in good agreement with experimental determinations (Analytical Sciences Sept 2002, Vol 18, pages 1015 to 1020). We prefer calculated Log P values, however, because commercial computer programmes exist which can accurately and quickly calculate the Log P values of large numbers of real or hypothetical compounds.

A review by Mannhold, R. and Dross, K. (Quant. Struct-Act. Relat. 15, 403-409, 1996) describes 14 methods for calculating Log P values of compounds and especially drugs. From this review we prefer the “fragmental methods” and especially the fragmental method implemented by ACD labs software.

The calculated Log P of a monoethylenically unsaturated monomer may be calculated using commercially available computer software, for example using the Log P DB software version 7.04 or a later version of such software (which is available from Advanced Chemistry Development Inc (ACD labs)). Any ionic or ionisable groups are calculated in their neutral (unionised) form.

Preferably, the one or more monoethylenically unsaturated hydrophilic monomers each have a calculated Log P value of less than 1, more preferably from less than 1 to −6.

The monoethylenically unsaturated hydrophilic monomers may have ionic and/or non-ionic hydrophilic groups. The ionic groups may be cationic but are preferably anionic. Both cationic and anionic groups may be present to give amphoteric stabilisation. Preferred anionic groups are phenolic, sulphonic acid, sulphuric, phosphonic, polyphosphoric, phosphoric acid and especially carboxylic acid groups which may be in the free acid or salt. Suitable salts include alkali metal, ammonium, and organic amine salts. Preferred alkali metal salts include lithium and especially sodium and potassium.

Preferred cationic groups are quaternary ammonium, benzalkonium, guanidine, biguanidine and pyridinium. These can be in the form of a salt such as a hydroxide, sulphate, nitrate, chloride, bromide, iodide and fluoride.

Suitable hydrophilic non-ionic groups are glucoside, saccharide, pyrrolidone, acrylamide, hydroxy groups, poly(ethyleneoxide) groups, for example groups of the formula —(CH₂CH₂O)ₙH or —(CH₂CH₂O)ₙC₁₋₄-alkyl wherein n is from 3 to 200 (preferably 4 to 20). Preferably, the total of all monomers containing non-ionic hydrophilic groups in the copolymerisation composition is less than 2% by weight relative to all the monomers in components i) to iii). Preferably, however, these hydrophilic non-ionic groups are not present in the dispersant.

In some embodiments the dispersant may contain, for example, a single hydrophilic non-ionic group, several hydrophilic non-ionic groups throughout the dispersant or one or more polymeric chains containing hydrophilic non-ionic groups. Hydroxy groups can be incorporated using polymeric chains such as polyvinylalcohol, polyhydroxy functional acrylics and celluloses. Ethyleneoxy groups can be incorporated using polymeric chains such as polyethyleneoxide.

Suitable hydrophilic monoethylenically unsaturated monomers include hydrophilic non-ionic and ionic (meth)acrylate monomers.

Suitable hydrophilic non-ionic monoethylenically unsaturated monomers are those containing saccharide, glucoside, amide, pyrrolidone and especially hydroxy and polyethyleneoxy groups.

Suitable examples of hydrophilic non-ionic monoethylenically unsaturated monomers include hydroxyethyl acrylate, hydroxyethyl methacrylate, vinyl pyrrolidone, polyethyleneoxide functional (meth)acrylates and (meth)acrylamides.

Hydrophilic ionic monoethylenically unsaturated monomers may be cationic but are preferably anionic.

Preferred hydrophilic anionic monoethylenically unsaturated monomers are those comprising carboxylic, phosphoric acid, phosphonic groups and/or sulphonic acid groups which may be in the free acid form or salts thereof. The types of salts are as described hereinbefore. Preferred examples are acrylic acid, methacrylic acid, betacarboxy ethyl acrylate, styrenesulphonic acid, vinylbenzylsulphonic acid, vinylsulphonic acid, acryloyloxyalkyl sulphonic acids (for example, acryloyloxymethyl sulphonic acid, acryloyloxyethyl sulphonic acid, acryloyloxypropyl sulphonic acid and acryloyloxybutyl sulphonic acid), methacryloyloxymethyl sulphonic acid, methacryloyloxyethyl sulphonic acid, methacryloyloxypropyl sulphonic acid and methacryloyloxybutyl sulphonic acid), 2-acrylamido-2-alkylalkane sulphonic acids (for example, 2-acrylamido-2-methylethanesulphonic acid, 2-acrylamido-2-methylpropanesulphonic acid and 2-acrylamido-2-methylbutane sulphonic acid), 2-methacrylamido-2-alkylalkane sulphonic acids (for example, 2-methacrylamido-2-methylethanesulphonic acid, 2-methacrylamido-2-methylpropanesulphonic acid and 2-methacrylamido-2-methylbutanesulphonic acid), mono-(acryloyloxyalkyl)phosphates (for example, mono(acryloyloxyethyl)phosphate and mono(3-acryloyloxypropyl)phosphates) and mono (methacryloyloxyalkyl)phosphates (for example, mono (methacryloyloxyethyl)phosphate and mono(3-methacryloyloxypropyl)phosphate).

Of these methacrylic acid is especially preferred. Preferably, the monoethylenically unsaturated hydrophilic monomer(s) when present comprise and more preferably is methacrylic acid. Preferably component i) is or comprises (meth) acrylic acid.

In some cases it is preferred that component i) is or comprises a hydrophilic monoethylenically unsaturated monomer comprising a boronic acid group. A preferred example of which is 4-vinyl phenyl boronic acid. We have found that the use of boronic acid groups can be helpful in the fastness of the dispersions to printed substrates especially cellulosic substrates (e.g. paper).

It is particularly preferred that the dispersant has no hydrophilic non-ionic groups, more preferably the only hydrophilic group in the dispersant is a carboxylic acid or a salt thereof.

Suitable hydrophilic cationic monoethylenically unsaturated monomers are those comprising tertiary amine, quaternary amine, pyridine, guanidine and biguanidine groups.

Preferably, regardless of conditions A) and B) in the first aspect of the present invention, the ratio of the total hydrophilic groups in all of the one or more monoethylenically unsaturated hydrophilic monomers of component i) expressed in moles to the total amount of hydrophilic groups in all the chain transfer agents of component iv) expressed in moles is less than 5:1, more preferably less than 3:1, especially preferably less than 1:1, more especially less than 0.3:1 and most especially less than 0.1:1. Any chain transfer groups in the chain transfer agent (e.g. —SH groups) are not treated as hydrophilic groups.

These preferred ratios result in larger proportions of the hydrophilic groups present in the dispersant being attached via a chain transfer agent group rather than from component i). We have surprisingly found that such copolymers offer improved properties as dispersants for pigments. In particular such dispersants provide pigment dispersions which offer an improved balance of properties such as colloidal stability, reflectance optical density when printed and effectiveness during pigment milling to prepare sub micro dispersions.

A largely equivalent expression for the above preferred ratios is that it is preferred that at least 20 mol %, more preferably at least 25 mol %, especially at least 50 mol %, more especially at least 75 mol % and most especially at least 90 mol % of the total hydrophilic groups present in the dispersant are attached to a chain transfer agent group, said chain transfer group being attached to the dispersant. By attached we mean via covalent bonds.

In some cases it is preferred that the component i) is not present (I.e. zero parts of component i). In this way all of the hydrophilic groups in the dispersant are attached to transfer agent group (from component iv), said chain transfer agent being attached to the dispersant.

Preferably, component i) is present at from 0 to 45 mol %, more preferably 0 to 20 mol %, especially 0 to 5 mol % based on the total number of moles of all the components i) to iii) as defined in the first aspect of the present invention. In some cases component i) is absent (zero parts).

### Component ii)

The monoethylenically unsaturated hydrophobic monomers may be all of the same chemical formula or they may comprise two or more (e.g. two to ten) different monoethylenically unsaturated hydrophobic monomers.

Preferably, the one or more monoethylenically unsaturated hydrophobic monomers each have calculated Log P value (as previously described) of 1 or more. More preferably from 1 to 6.

Preferably, the one or more monoethylenically unsaturated hydrophobic monomers each have a solubility in water of 50 g/L or less. The solubility is preferably measured by the previously described method.

Monoethylenically unsaturated hydrophobic monomers are typically free from ionic and non-ionic hydrophilic groups. Preferred examples include esters of (meth)acrylic acid. Preferably, the one or more monoethylenically unsaturated hydrophobic monomers comprises an ester of (meth)acrylic acid. More preferably, all of the one or more monoethylenically unsaturated hydrophobic monomers are esters of (meth)acrylic acid.

Preferred monoethylenically unsaturated hydrophobic monomers include C₁₋₂₀-hydrocarbyl (meth)acrylates, styrene and vinyl naphthalene. Especially preferred are C₁₋₁₀-hydrocarbyl (meth)acrylates for example methyl (meth)acrylate, ethyl (meth)acrylate, butyl (meth)acrylate, 2-ethyl hexyl (meth) acrylate and benzyl (meth)acrylate.

Preferably, component ii) is or comprises benzyl (meth) acrylate, more preferably is or comprises benzyl methacrylate.

Benzyl methacrylate is especially preferred as we have found it tends to improve the reflectance optical density of prints made from dispersions prepared by the process of the first aspect of the present invention.

It is preferred that component ii) comprises at least 50 weight percent, more preferably at least 60 weight percent, especially at least 75 weight percent and most especially at least 90 weight percent of benzyl methacrylate relative to all the monomers in component ii).

It is sometimes preferred that component ii) consists only of benzyl (meth) acrylate, especially only of benzyl methacrylate.

Preferably, component ii) is present at from 50 to 95 mol %, more preferably 50 to 90 mol %, especially 50 to 80 mol % based on the total number of moles of all the components i) to iii) as defined in the first aspect of the present invention.

Component iii)

Diethylenically unsaturated monomers have two ethylenically unsaturated groups.

The diethylenically unsaturated monomers and higher ethylenically unsaturated monomers may be all of the same chemical formula or they may comprise two or more (e.g. two to ten) different diethylenically unsaturated monomers and higher ethylenically unsaturated monomers.

As used herein the word “higher” when applied to ethylenically unsaturated groups means having more than two, more preferably three or more ethylenically unsaturated groups.

Preferred diethylenically unsaturated monomers and higher ethylenically unsaturated monomers have on average from two to five ethylenically unsaturated groups per molecule.

Preferably, component iii) contains no higher ethylenically unsaturated monomers.

The di- and or higher-ethylenically unsaturated monomers may be oligomeric in nature.

Preferably, the random copolymer contains no repeat units from the copolymerisation of higher ethylenically unsaturated monomers.

Examples of diethylenically unsaturated monomers include, but are not limited to divinylbenzene, bis-(4-ethenylphenyl)methane, divinyldioxane, divinyl ether, 1,4-butanediol divinyl ether, hexanediol divinyl ether, cyclohexanediol divinyl ether, ethylene glycol divinyl ether, diethylene glycol divinyl ether, cyclohexanedimethanol divinyl ether, 1,3-divinyl-1,1,3,3-tetramethyldisilazane, divinyl 1,3-diphenyl-1,3-dimethyldisilazane, divinyl tetraethoxy-1,3-disilazane, divinyl tetramethoxy-1,3-disilazane, divinyl 1,3-diphenyl-1,3-dimethyl-1,3-disiloxane, divinylacetylene, N,N-divinylaniline, divinylcarbinol, divinylcarbonate, 1,2-divinylcyclobutane, cis-1,2-divinylcyclohexane, trans-1,2-divinylcyclohexane, 1,4-divinylcyclohexanedimethanol diether, divinyldibutyltin, 2,5-divinyldioxane, 1,1′-divinylferrocene, divinylformal, divinyl glycol, 1,4-divinylperfluorobutane, 1,6-divinylperfluorohexane, divinylphenylphosphine, 3,9-divinylspirobim-dioxane, divinylsulphone, 1,4-divinyl-1,1,4,4-tetramethyldisilylethylene, divinyl tin dichloride, divinyl triethylene glycol diether, 1,5-bis-divinyloxy-3-oxapentane, divinylsilane, divinyldiethoxysilane, divinyldimethylsilane, divinyldiphenylsilane, 1,1′-bis(2-vinyloxyethoxy)-4,4′-isopropylidene diphenol, ethylene glycol dimethacrylate, bisphenol A dimethacrylate, bisphenol A 2-hydroxyethyl dimethacrylate, 1,3-butylene glycol dimethacrylate, 1,4-butanediol dimethacrylate, butenediol dimethacrylate, 2-butyl-2-ethyl-1,3-propanediol dimethacrylate, 2-butyne-1,4-diyl dimethacrylate, 1,4-cyclohexanediol dimethacrylate, decamethylene glycol dimethacrylate, diethylene glycol dimethacrylate, 2,3-dihydroxypropyl dimethacrylate, 1,6-dimethylhexanediol dimethacrylate, 2,5-dimethylhexanediol dimethacrylate, dipropylene glycol dimethacrylate, diurethane dimethacrylate, 1,12-dodecanediol dimethacrylate, ethylidene dimethacrylate, glycerol dimethacrylate, 1,5-tetrahydroperfluoropentyl dimethacrylate, hexafluorobisphenol A dimethacrylate, hexylene glycol dimethacrylate, hydrogenated bisphenol A dimethacrylate, methylene glycol dimethacrylate, neopentyl glycol dimethacrylate, 2,2,3,3,4,4,5,5-octafluorohexanediol 1,6-dimethacrylate, pentaerythritol dimethacrylate, 1,5-pentanediol dimethacrylate, perfluorocyclohexyl 1,4-dimethyl dimethacrylate, o-phenylene dimethacrylate, p-phenylene dimethacrylate, styrene glycol dimethacrylate, polyethylene glycol 600 dimethacrylate, polyethylene glycol 400 dimethacrylate, 1,2-propylene glycol dimethacrylate, propylene glycol dimethacrylate, sorbitol dimethacrylate, 4,4′-sulphonyl diphenol dimethacrylate, tetrabromo bisphenol A dimethacrylate, tetrachloro bisphenol A dimethacrylate, tetraethylene glycol dimethacrylate, 2,2,3,3-tetrafluorobutanediol dimethacrylate, triethylene glycol dimethacrylate, trimethyl pentanediol dimethacrylate, urethane dimethacrylate, zinc dimethacrylate, zirconium(IV) dimethacrylate, butanediol diacrylate, N,N-diacryloyl acrylamide, bisphenol A diacrylate, bisphenol A 2-hydroxyethyl diacrylate, 1,3-butylene glycol diacrylate, 1,4-butanediol diacrylate, 1,10-decanediol diacrylate, propoxylated neopentyl glycol diacrylate, ethoxylated bisphenol A diacrylate and dimethacrylate, ethylene glycol dimethacrylate, tetraethylene glycol diacrylate, tri-propylene glycol dimethacrylate, diethyl 1,3-propanediol diacrylate, diethylene glycol diacrylate, dimethyl bisphenol A diacrylate, dipropylene glycol diacrylate, ethyl 1,3-hexanediol diacrylate, ethylene diacrylate, ethylidene diacrylate, hexafluorobisphenol A diacrylate, 1,6-hexanediol diacrylate, 2,5-hexanediol diacrylate, neopentyl glycol diacrylate, propoxylated neopentyl glycol diacrylate, 1,9-nonamethylene diacrylate, 2,2,3,3,4,4,5,5-octafluorohexanediol 1,6-diacrylate, 1,5-pentanediol diacrylate, p-phenylene diacrylate, polyethylene glycol 400 diacrylate, 1,2-propylene glycol diacrylate, propylene glycol diacrylate, sorbitol diacrylate, tetrabromobisphenol A diacrylate, polyethylene glycol 200 diacrylate, 2,2,3,3-tetrafluorobutanediol diacrylate, thiol diethylene glycol diacrylate, triethylene glycol diacrylate, tripropylene glycol diacrylate, urethane diacrylate, zinc diacrylate, diethylene glycol diacryloxypropionate, bis-acryloyl piperazine and diallyl maleate.

Preferred diethylenically unsaturated monomers include divinylbenzene and/or diurethane di(meth)acrylate. In some cases it is preferred that component iii) consists only of divinylbenzene and/or diurethane di(meth)acrylate.

Higher-ethylenically unsaturated monomers have more than two, preferably, three or more ethylenically unsaturated groups, e.g. 3 or 4 of such groups. Preferred higher ethylenically unsaturated monomers include triethylenically unsaturated monomers and tetraethylenically unsaturated monomers.

Examples of triethylenically unsaturated monomers include triacrylformal, pentaerythritol triallyl esters, glyceryl propoxy triacrylate, ferric triacrylate, pentaerythritol triacrylate, triazine-2,4,6-triyl-1,2-ethanediyl triacrylate, trimethylol ethane triacrylate, trimethylol propane triacrylate, ethoxylated trimethylol ethane triacrylate, ethoxylated trimethylol propane triacrylate, glycerol trimethacrylate, proproxylated glycerol triacrylate, pentaerythritol trimethacrylate, 1,2,5-pentanetriol trimethacrylate, triethanolamine trimethacrylate, trimethylol ethane trimethacrylate, trimethylol propane trimethacrylate, tris(2-hydroxyethyl) isocyanurate trimethacrylate.

Examples of tetraethylenically unsaturated monomers include pentaerythritol tetraacrylate, zirconium(IV) tetraacrylate, pentaerythritol tetramethacrylate, and zirconium(IV) tetramethacrylate.

Preferably, component iii) is present at from 5 to 50 mol %, more preferably 10 to 50 mol %, especially 20 to 50 mol % based on the total number of moles of all the components i) to iii) as defined in the first aspect of the present invention.

### Component iv)

One function of the chain transfer agent (CTA) is to avoid premature cross-linking and subsequent gelling of the dispersant which would otherwise result from the presence of the di- and/or higher-ethylenically unsaturated monomers. In addition we speculate that the hydrophilic groups in at least one of the CTAs assists in obtaining a more desirable balance of properties such as stability, ease of pigment milling and high optical density when printed.

While not wishing to be bound or limited by any theory, it is believed that the presence of the di- and/or higher-ethylenically unsaturated monomers creates random branching points in the growing random copolymer and the chain transfer agents serve to limit the molecular weight of the individual polymer chains, while not particularly limiting the overall molecular weight of the dispersant, thereby avoiding gelling.

Thus, the dispersant is a branched dispersant, preferably a highly branched dispersant.

Preferred chain transfer agents (CTAs) contain one or more sulphur atoms. Such CTAs include thiols, polysulfides (especially disulfides) and thioethers, thioesters and thiocarbamates.

Preferred chain transfer agents have at least one, more preferably only one —SH (thiol) group.

Preferred chain transfer agents (CTAs) have just one hydrophilic group. For CTAs a hydrophilic group is other than the chain transfer group. Thus for example —SH is not considered to be a hydrophilic group for a CTA.

The chain transfer agents preferably have one or more hydrophilic groups selected from non-ionic, cationic and especially anionic groups. The possible hydrophilic groups are as previously described for the monomers.

Preferred hydrophilic anionic group(s) on the CTA include sulfonic acid, phosphonic acid and especially carboxylic acid group(s).

Preferred hydrophilic non-ionic group(s) on the CTA include hydroxy and polyethyleneoxy.

Preferred chain transfer agents having one or more hydrophilic groups include:
i) mercapto acids, preferably thioglycolic acid, mercaptoundecanoic acid, thiolactic acid, thiobutyric acid, thiomalic acid, thiomalonic acid, thioadipic acid, 2-mercapto ethane sulfonic acid, and especially 3-mercapto propionic acid;
ii) mercapto alcohols, preferably 2-mercaptoethanol, mercaptopropanol, mercapto butanol, 3-mercapto-1,2-propanediol, thioglycerol, ethylene glycol mono thio glycolate;
iii) mercapto amines and especially cysteine.

Of all of the above a preferred chain transfer agent having one or more hydrophilic groups is 3-mercaptopropionic acid.

Preferably, the CTA is not acrolein or (meth)acrolein.

In some cases component iv) as defined in the first aspect of the present invention may contain one or more chain transfer agents having no hydrophilic groups (of course other than the chain transfer group itself). These may be simply referred to as hydrophobic CTAs. When present preferred “hydrophobic” CTAs include mercaptans, e.g. octyl mercaptan, n-dodecyl mercaptan, t-dodecyl mercaptan, n-hexadecyl mercaptan, n-tetradecyl mercaptan and t-tetradecyl mercaptan, butyl 3-mercaptopropionate; xanthogenndisulfides, e.g. dimethyl xanthogenndisulfide, diethyl xanthogenndisulfide and diisopropyl xanthogenndisulfide; thiuram disulfides, e.g. tetramethyl thiuram disulfide, tetraethyl thiuram disulfide and tetrabutyl thiuram disulfide; halogenated hydrocarbons, e.g. carbon tetrachloride and ethylene bromide; hydrocarbons e.g. pentaphenylethane; unsaturated cyclic hydrocarbon compounds such as, 2-ethylhexyl thioglycolate, terpinolene, alpha terpinene, gamma terpinene, diterpene, alpha methylstyrene dimer, 9,10-dihydroanthracene, 1,4-dihydronaphthalene, indene and 1,4-cyclohexadiene; unsaturated heterocyclic compounds such as xanthene and 2,5-dihydrofuran; cobalt chelate compounds; and the like. These hydrophobic chain transfer agents can be used alone or in admixture of at least two kinds.

It is preferred that in component iv) the ratio of the total number of moles of the CTAs having one or more hydrophilic groups to the total number of moles of all the CTAs having no hydrophilic groups is 1:1, more preferably 5:1, especially 10:1 and it is especially preferred that component iv) comprises only CTAs which have one or more hydrophilic groups. In this way all the CTA that binds to the copolymer provides CTA groups which have hydrophilic groups. Again, the chain transfer groups are not counted as hydrophilic groups.

The optimum total amounts of chain transfer agent(s) to be used in a composition will depend on the amount of di- and/or higher-ethylenically unsaturated monomers present, the number of ethylenically unsaturated groups they have and their reactivities. One may determine the optimum amount of total chain transfer agent(s) to be used experimentally, e.g. by first polymerising the composition without any chain transfer agent(s) present, then repeating the polymerisation using increasing amounts of chain transfer agent(s). The point at which no gellation occurs indicates the minimum amount of chain transfer agent(s) to be used. Slightly more than this minimum amount will usually be used to ensure gel formation is avoided.

In our experiments we observed, as an approximation, that the number of moles of total chain transfer agent(s) to use (M_{CTA}) per mole of each di- or higher-ethylenically unsaturated monomers present in the composition is given by the equation:

M_{CTA}=y(n−1)

wherein:

n is the number of ethylenically unsaturated groups in the di- and higher-ethylenically unsaturated monomer; and

y is 0.7 to 6, more preferably 0.7 to 3, especially 0.9 to 2 and most especially about 1.

Thus, considering y is from 0.9 to 2 then for a diethylenically unsaturated monomer one could use 0.9 to 2 moles of chain transfer agent per mole of the diethylenically unsaturated monomer. For a triethylenically unsaturated monomer one could use 1.8 to 4 moles of chain transfer agent per mole of the triethylenically unsaturated monomer. For a tetraethylenically unsaturated monomer one could use 2.7 to 6 moles of chain transfer agent per mole of the tetraethylenically unsaturated monomer. For a mixture of di- and triethylenically unsaturated monomers one would calculate the amount of chain transfer agent required for each monomer as indicated above and include that amount in the composition. Put simply, one may use for example 0.7(n−1) to 3(n−1) moles of chain transfer agent per mole of di- or higher-ethylenically unsaturated monomer, where n is the number of ethylenically unsaturated groups in the di- or higher-ethylenically unsaturated monomer. Of course when using more than one chain transfer agent this total amount in moles may be split in a number of ways between the different CTAs present, provided the total amounts of CTAs agrees with the above preferred formula.

The equation works best for sulphur containing, especially thiol containing CTAs. The equation works especially well when the copolymerisation composition comprises (meth)acrylate monomers.

Preferably, all of the CTA(s) in component iv) used in the above preferred amounts, has/have one or more hydrophilic groups.

### Preferred Copolymerisation Compositions

A preferred copolymerisation composition comprises:
i) 0 to 45 mol %, more preferably 0 to 20 mol %, especially 0 to 5 mol % of monoethylenically unsaturated hydrophilic monomers;
ii) 50 to 95 mol %, more preferably 50 to 90 mol %, especially 50 to 80 mol % of monoethylenically unsaturated hydrophobic monomers,
iii) 5 to 50 mol %, more preferably 10 to 50 mol %, especially 20 to 50 mol % of di- and/or higher ethylenically unsaturated monomers;
   wherein mol % is based on the total number of moles of all monomers i) to iii), the total mol % of monomers i) to iii) is 100%; and
iv) 0.7(n−1) to 3(n−1) moles of total chain transfer agent(s) per mole of di- or higher-ethylenically unsaturated monomer(s), where n is the number of ethylenically unsaturated groups in the di- or higher-ethylenically unsaturated monomer(s); and
v) 0.1 to 15 wt %, more preferably 1 to 10 wt % of free radical initiator(s) based on the sum of the weights of components i) to iii).

The composition may of course contain further ingredients in addition to components i. to v. (e.g. diluents). Typically the abovementioned components are dissolved or dispersed in a liquid medium, e.g. in a weight ratio of components i. to v. to liquid medium of from 1:1.5 to 1:10, more preferably from 1:1.5 to 1:4.0.

The dispersant is preferably chosen to suit the liquid medium to be used in the process for preparing the dispersion and also the liquid vehicle to be used in any final intended composition in which the particulate solid will be used (e.g. inks). Thus, for example, when the particulate solid is to be used in an aqueous ink jet printing ink the dispersant preferably has a significant proportion of hydrophilic groups. Similarly, when the particulate solid is to be used in an oil-based (non-aqueous) ink the dispersant preferably has a significant amount of hydrophobic groups.

### Initiator

Preferably, the copolymerisation composition used to make the dispersant further comprises an initiator, especially a free radical initiator. Preferably, the initiator is thermally activated.

Examples of free radical initiators include azo compounds such as 2,2′-azobis(isobutyronitrile), 2,2′-azobis-(2-methyl)butanenitrile,4,4′-azobis(4-cyanovaleric acid), 2-(t-butylazo)-2-cyanopropane, and 2,2′-azobis[2-methyl-N-hydroxyethyl)]-propionamide. Other soluble free radical initiators may also be used, examples of which include peroxy compounds such as benzoyl peroxide, lauroyl peroxide, hydrogen peroxide, and sodium, potassium and ammonium persulphates. Redox initiator systems can also be used, examples of which include redox pairs such as ammonium persulphate and sodium metabisulphite.

The initiator may be present in the composition in an amount from 0.1 to 15%, especially from 1 to 10% and most especially from 1 to 5% by weight based on the total amount of ethylenically unsaturated monomers present in the copolymerisation composition. When higher levels of chain transfer agent are used it is also sometimes advantageous to also increase the levels of initiator.

### Preferred Dispersants

The acid value (AV) of the dispersant is preferably from 50 to 400 mg, more preferably from 50 to 200 mg and especially from 50 to 150 mg KOH/g. Dispersants having such acid values provide a resultant dispersion which exhibits particularly high stability and good OD. High stability is especially useful in the demanding liquid vehicles used in ink jet printing and with more difficult to disperse particulate solids.

The molecular weight of the dispersant may be varied widely, with number average molecular weights preferably being 500 to 100,000, more preferably 1,000 to 50,000 and especially from 1,000 to 35,000. The molecular weight is preferably measured by triple detection gel permeation chromatography (“GPC”). The dispersant need not be totally soluble in the liquid medium. That is to say perfectly clear and non-scattering solutions are not essential. The dispersant may aggregate in surfactant-like micelles giving slightly hazy solutions in the liquid medium. The dispersant may be such that some proportion of the dispersant tends to form a colloid or micellar phase. It is preferred that the dispersant produces uniform and stable dispersions in the liquid medium which do not settle or separate on standing.

It is preferred that the dispersant is substantially soluble in the liquid medium (especially water), giving rise to clear or hazy solutions.

### Ionic Groups in the Dispersant

When the dispersant comprises ionic groups these are preferably in the form of the salt. For acidic groups preferred salts include alkali metal, ammonium, and organic amine salts. For cationic groups the preferred salts include halide, nitrate and sulphate. Preferably, the dispersant has no cationic groups.

When the dispersant comprises acidic groups (e.g. carboxy and/or sulpho groups) the process preferably further comprises the step of neutralising such acidic groups, for example using an alkali metal salt (especially sodium hydroxide or potassium hydroxide).

### Dispersant Log P

Preferably, the dispersant has a calculated Log P of no more than 4.0, more preferably from −1 to 4.0, more preferably from 1.0 to 4.0. The calculated Log P may be determined by the method described in WO 2005/061087, page 9, line 35 to page 10, line 21, which is incorporated herein by reference thereto.

### Dispersant Acidic Groups

Preferably, the dispersant has one or more acid groups. The acid groups are preferably sulfonic acid, phosphoric acid, phosphonic acid and especially carboxylic acid. Preferably, the only acid group(s) present in the dispersant are carboxylic acid group(s). Preferably, the only hydrophilic groups present in the dispersant are carboxylic acid groups.

When the dispersant is to be cross-linked with a cross-linking agent the dispersant preferably has two or more carboxylic acid groups per molecule.

The carboxylic acid group(s) may be present in the dispersant in the form of a free acid (—COON) or more preferably in the form of a salt. The salt may be, for example, an alkali metal ion, an ammonium, substituted ammonium, quaternary ammonium or pyridinium salt.

Carboxylic acid group(s) may, but preferably are not, incorporated into the dispersant by, for example, copolymerising one or more monoethylenically unsaturated hydrophilic monomers in component i) containing at least one carboxylic acid group. Examples of such monomers include itaconic acid, maleic acid, fumaric acid, crotonic acid, more preferably methacrylic acid, acrylic acid and beta carboxy ethyl acrylate.

It is more preferred that the carboxylic acid groups in the dispersant are predominantly or exclusively incorporated by the use of carboxylic acid functional chain transfer agents in component iv).

The dispersant may optionally have other stabilising groups. The choice of the stabilising groups as well as the amounts of such groups will depend to a large extent on the nature of the liquid medium. Stabilising groups tend to be either hydrophilic in nature (e.g. for polar liquid media) or hydrophobic in nature (e.g. for non-polar liquid media).

Preferably however, the dispersant has no hydrophilic non-ionic groups. Hydrophilic non-ionic groups which are preferably absent include polyalkyleneoxy (especially polyethyleneoxy) and hydroxy groups.

### Optional Dispersant Precipitation

The process may optionally further comprise the step of mixing the dispersant with a nonsolvent to form a precipitate of the dispersant, separating the precipitated dispersant from the nonsolvent and adding the separated dispersant to fresh solvent. This further step is preferably performed prior to the dispersant coming into contact with the particulate solid. Sometimes the nonsolvent is a non-polar liquid and the solvent is a polar liquid (e.g. water or a mixture of water and one or more water-miscible organic liquids). There are alternative means of dispersant precipitation including pH, electrolyte and low temperature induced precipitation.

### Liquid Medium

The liquid medium may be non-polar but is preferably polar. “Polar” liquid media are generally capable of forming moderate to strong bonds, e.g. as described in the article entitled “A Three Dimensional Approach to Solubility” by Crowley et al in Journal of Paint Technology, Vol. 38, 1966, at page 269. Polar liquid media generally have a hydrogen bonding number of 5 or more as defined in the abovementioned article.

Examples of suitable polar liquid media include ethers, glycols, alcohols, polyols, amides and especially water.

Preferably, the liquid medium is or comprises water as this tends to result in a particularly stable and fine dispersion. Accordingly, preferred liquid media are aqueous. Preferably, the liquid medium comprises from 1 to 100%, more preferably from 10 to 100%, especially from 30 to 90% and more especially from 50 to 90% water by weight. The remainder is preferably one or more polar organic liquids. Particularly preferred polar organic liquids are 2-methyl pyrrolidone, acetone, methyl ethyl ketone, tetrahydrofuran, isopropanol, dipropylene glycol and mixtures thereof.

It is preferred that all of the components of the liquid medium are polar liquids.

When the liquid medium comprises more than one liquid said liquid medium may be in the form of a multi phase liquid (e.g. a liquid-liquid emulsion) but is preferably in the form of a single phase (homogeneous) liquid.

Preferably, the polar liquids other than water are water-miscible.

In a preferred embodiment the liquid medium comprises water and a water-miscible organic liquid. Such a liquid medium is preferred because it enhances the effectiveness of the mechanical treatment step and speeds the reduction in the average particle size of the particulate solid. It also assists in dissolving more hydrophobic dispersants.

Preferred water-miscible organic liquids for inclusion into the liquid medium include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; water-miscible ethers, preferably tetrahydrofuran and dioxane; diols, preferably diols having from 2 to 12 carbon atoms, for example ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy) ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone. Ketones (e.g. methyl ethyl ketone and acetone), aldelhydes and low molecular weight esters may also be suitable employed as water-miscible organic liquids.

Preferably, the liquid medium comprises water and 1 or more, especially from 1 to 3, water-miscible organic liquids.

The weight ratio of water to water-miscible organic liquid when both are present in the liquid medium is preferably from 99:1 to 5:95, more preferably 95:5 to 50:50, especially 95:5 to 65:35.

### Dispersion Step

The particulate solid, the liquid medium and the dispersant may be dispersed in any order or simultaneously. Preferably, the particulate solid is dispersed in a liquid medium comprising the dispersant.

The dispersion step is effected by a mechanical treatment to reduce the particle size of the particulate solid. Mechanical treatment to reduce particle size tends to require large amounts of energy. Examples of suitable mechanical treatments include ball milling, bead milling, gravel milling or by more elaborate techniques such as ultrasonication, microfluidizing (using a Microfluidics™ machine) or using hydrodynamic cavitation (using for example the CaviPro™ device). These are typically referred to as milling methods.

In many cases it is preferable to additionally employ a predispersion step prior to the above mechanical treatment e.g. stirring, shaking, rolling or kneading prior to the above high energy mechanical treatment. The predispersion step forms a course predispersion and has little or negligible effect in reducing the particle size of the dispersion.

The volume average particle size of the particulate dispersion after the mechanical treatment process is preferably from 50 to 300 nm, more preferably from 50 to 250 nm and especially from 50 to 200 nm. The volume averaged particle size may be measured by any suitable method. Preferred methods include laser scattering, photon correlation spectroscopy, disc centrifuge photosedimentometry and transmission electron microscopy.

### Dispersion Work Up

If desired the dispersion may be filtered or centrifuged to remove any poorly dispersed or oversized particulate material. This can be done prior to formulation into an ink or optional cross-linking. In particular, the process preferably comprises filtering a mixture comprising the dispersant, particulate solid and liquid medium (preferably prior to cross-linking if cross-linking is performed), preferably through a filter having a pore size of less than 10, more preferably less than 5 and especially less than 1 micron.

The dispersion may be purified by for example cross-flow membrane treatment, filter washing or centrifugation and decantation. In this way the amounts of salts and free dispersant may be reduced.

### Encapsulated Particulate Solids

Preferably, the process according to the first aspect of the present invention further comprises the step of cross-linking the dispersant with a cross-linking agent in the presence of the particulate solid and the liquid medium, thereby encapsulating the particulate solid within the cross-linked dispersant. This prepares encapsulated particulate solids having among other things improved colloidal stability towards for example storage, heat and water miscible organic liquids.

Thus, according to a second aspect of the present invention there is provided an encapsulated particulate solid obtainable or obtained by the process of the first aspect of the present invention further comprises the step of cross-linking the dispersant with a cross-linking agent in the presence of the particulate solid and the liquid medium, thereby encapsulating the particulate solid within the cross-linked dispersant.

The encapsulated solid may be in the form of a dispersion in the liquid medium. Alternatively, the encapsulated solid may be isolated from the liquid medium by for example oven drying, spray drying, freeze drying and the like.

When the dispersant is cross-linked it is preferred that the dispersant is adsorbed onto the particulate solid prior to cross-linking so as to form a relatively stable dispersion. In addition, the mechanical treatment which reduces the particle size is preferably performed prior to cross-linking the dispersant. This dispersion is then cross-linked using the cross-linking agent, preferably in the presence of a borate compound. This pre-adsorption and pre-stabilisation differs from coacervation approaches. In coacervation approaches a polymer or prepolymer (which is not a dispersant) is mixed with a particulate solid, a liquid medium and a cross-linking agent and only during or after cross-linking does the resultant cross-linked polymer precipitate onto the particulate solid.

The cross-linking agent may be of any suitable kind provided that it is able to cross-link the dispersant molecules. When the dispersant contains carboxylic acid groups the preferred cross-linking agents include isocyanate, oxazoline, aziridine, carbodiimide, melamine formaldehyde resin and especially epoxide cross-linking agents. Cross-linking agents may have two or more cross-linking groups. Preferred cross-linking agents have from 2 to 10, and especially from 2 to 5 cross-linking groups.

The cross-linking agent may or may not contain an oligomeric dispersing group.

When present the oligomeric dispersing group preferably is or comprises polyalkyleneoxide, more preferably a polyC₂₋₄-alkyleneoxide and especially a polyethyleneoxide. The polyalkyleneoxide groups provide steric stabilisation which improves the stability of the resulting encapsulated particulate solid.

Preferably the polyalkyeneoxide contains from 3 to 200, more preferably from 5 to 50 alkyleneoxide and especially from 5 to 20 alkyleneoxide repeat units.

Pairs of reactive and reactable groups which may be included in the cross-linking agent and dispersant respectively are as disclosed in International patent application WO 2005/061087, page 6, Table 1, which is incorporated herein by reference thereto. Preferably the dispersant has two or more carboxylic acid groups and the cross-linking agent has two or more epoxy groups.

Preferred cross-linking agents having two epoxy groups and zero oligomeric dispersing groups are ethylene glycol diglycidyl ether, resorcinol diglycidyl ether, neopentyl glycol diglycidyl ether, 1,6-hexanediol diglycidyl ether, hydrogenated bisphenol A diglycidyl ether and polybutadiene diglycidyl ether.

Preferred cross-linking agents having two epoxy groups and one or more oligomeric dispersing groups are diethylene glycol diglycidyl ether, poly ethylene glycol diglycidyl ether, dipropylene glycol diglycidyl ether and poly propylene glycol diglycidyl ether.

Preferred cross-linking agents having three or more epoxy groups and zero oligomeric dispersing groups are sorbitol polyglycidyl ether, polyglycerol polyglycidyl ether, pentaerythritol polyglycidyl ether, diglycerol polyglycidyl ether, glycerol poly glycidyl ether and trimethylolpropane polygycidyl ether.

A preferred example of a polymeric cross-linking agent is a copolymer comprising glycidyl (meth)acrylate repeat units.

Preferably, the cross-linking agent is soluble in the liquid medium, especially when the liquid medium is aqueous. The test for water solubility and its measurement is as previously described with regards to monomers.

More preferably the cross-linking agent has a water-solubility of at least 1% by weight at 25° C.

The cross-linking agent may have one or more ethylene glycol groups to help solubilise the cross-linking agent.

One, or more than one cross-linking agent can be used in the process. When more than one cross-linking agent is used these may have the same or different numbers of cross-linking groups.

It is preferred that the only cross-linking groups present on the cross-linking agent are epoxy groups.

The carboxylic acid group(s), when present in the dispersant, can be used to cross-link with groups reactive towards carboxylic acid groups (e.g. epoxy, isocyanate, oxazoline, aziridine, carbodiimide, N-methylol groups) in a cross-linking agent. In addition, any unreacted carboxylic acid groups may assist in the stabilisation of the final encapsulated particulate solid against flocculation and aggregation. Carboxylic acid groups are effective as stabilising groups in polar and more especially aqueous media.

When carboxylic acid group(s) are the only groups for stabilising the final encapsulated particulate solid dispersed in the liquid medium and the cross-linking agent has epoxy groups it is preferable to have a molar excess of carboxylic acid groups to epoxy groups to ensure that unreacted carboxylic acid groups remain after the cross-linking reaction has been completed. In one embodiment the ratio of moles of carboxylic acid groups to moles of epoxy groups is preferably from 10:1 to 1.1:1, more preferably from 5:1 to 1.1:1 and especially preferably from 3:1 to 1.1:1

Low temperatures for cross-linking are preferred as this results in lower levels of flocculation and particle size growth of the particulate solid in the liquid medium. Preferably, the cross-linking reaction is performed at a temperature below 100° C., e.g. from 10° C. to 90° C. and more preferably from 30° C. to 70° C.

The pH for the cross-linking reaction, when performed, is preferably at least 6, e.g. from 7 to 14, more preferably from 7 to 12 and especially preferably from 8 to 11.

Before the cross-linking reaction starts any acid groups in the dispersant may be in the form of the salt and/or the free acid as hereinbefore described. However in order to better effect the reaction between acid groups and for example epoxy groups in the cross-linking agent at a temperature of below 100° C. it is preferred for at least some of the carboxylic acid groups to be present in the form of the salt. The salt form may be obtained by adjusting the pH (of all the components present in the process according to the first aspect of the present invention) to at least 6 (preferably from 6 to 10) prior to cross-linking.

The pH adjustment can be done by adding any suitable base. Preferred bases include metal hydroxides, oxides, carbonates as well as amines, substituted amines and alkanolamines. Especially preferred bases are the alkali metal hydroxides, ammonia, triethylamine and triethanolamine. An especially preferred alkali metal hydroxide is potassium hydroxide.

The time for the cross-linking reaction depends to some extent on the temperature and the pH. However, a preferred time is from 1 to 24 hours, more preferably from 1 to 8 hours.

Preferably, the cross-linking is performed by a process comprising mixing the particulate solid, the dispersant, the cross-linking agent, the liquid medium and heating the mixture.

The components may be mixed by any suitable method, e.g. shaking, stirring and so on.

Preferably the cross-linking is performed by a process comprising mixing a composition comprising the following components in the specified proportions:
a) 30 to 99.7 parts, preferably 50 to 97 parts of the liquid medium;
b) 0.1 to 50 parts, preferably 1 to 30 parts of the particulate solid;
c) 0.1 to 30 parts, preferably 1 to 30 parts of the dispersant;
d) 0.001 to 30 parts, preferably 0.01 to 10 parts of the cross-linking agent;
   wherein the parts are by weight and the sum of the parts a)+b)+c)+d)=100.

Preferably, the composition contains 0 to 4, more preferably 0 to 3 molar equivalents of boric acid or borate compound per mole of epoxy groups (if any) in the cross-linking agent. For example, if the composition contains 1 mole of a diepoxide cross-linking agent, this would require 8 moles of boric acid/borate compound to satisfy the requirement of 4 molar equivalents of boric acid/borate compound per mole of epoxy groups in the cross-linking agent. When the composition does not contain an epoxy cross-linking agent then preferably it is free of boric acid/borate compounds.

If the cross-linking agent is present during mechanical treatment of the particulate solid this can result in undesirable pre-cross-linking of the dispersion before the particle size of the solid has been fully reduced.

Preferably, the encapsulated particulate solid has a volume average particle size of from 50 to 300 nm, more preferably from 50 to 250 nm and especially from 50 to 200 nm. Conventionally, particulate solids having a volume average size of less than 300 nm are difficult to effectively stabilise.

Particulate solids of this size are particularly useful in inks, especially ink jet printing inks.

After cross-linking the dispersion of encapsulated particulate solid may be purified by for example cross-flow membrane treatment, filter washing or centrifugation and decantation. Preferably, the purification is by means of cross-flow ultrafiltration. In this way the amounts of salts, free dispersant and residual cross-linking agent may be reduced.

### Use and Applications

The dispersions and encapsulated particulate solids prepared by the process according to the first aspect of the present invention may be used as inks ‘as is’ or, more usually, the dispersions will be mixed with one or more further ingredients in order to provide an ink having the desired properties. Preferably, any acidic groups in the dispersant are neutralised before the dispersion is converted into an ink.

The further ink ingredients include water, organic liquids (especially water-miscible organic liquids), surfactants (especially Surfynol™ surfactants), binders, preservatives, anti-cockle agents, anti-kogation agents, metal chelating agents, biocides and other ingredients used in ink formulations. The organic liquids used are preferably those used in the art of ink jet printing inks.

Thus, the process may additionally comprise the step of adding one or more of the above further ink ingredients. Normally, addition of these ingredients will be done after the mechanical treatment step.

According to a third aspect of the present invention there is provided an ink containing an encapsulated particulate solid according to the second aspect of the present invention and a liquid medium.

A preferred ink according to the third aspect of the present invention comprises:
a) from 0.1 to 40 parts, more preferably from 1 to 25 parts, especially 1 to 15 parts of an encapsulated particulate solid according to the second aspect of the present invention; and
b) from 60 to 99.9 parts, more preferably from 75 to 99 parts, especially 85 to 99 parts of a liquid medium comprising water and/or a water-miscible organic liquid;
   wherein all parts are by weight and components a) and b) add to 100 parts.

### Ink Jet Printing Inks

Preferably, the ink is suitable for use in an ink jet printer.

In the case of ink jet printing, the ink preferably has a viscosity of less than 30 mPa·s, more preferably less than 20 mPa·s and especially less than 10 mPa·s when measured at a temperature of 25° C.

In the case of ink jet printing it is preferred that the ink has a surface tension from 20 to 65 dynes/cm, more preferably from 25 to 50 dynes/cm when measured at a temperature of 25° C.

It is preferred that the ink contains at least one water miscible organic liquid as hereinbefore mention and as previously preferred.

Preferably, the ink has been purified to remove low molecular weight salts. Examples of suitable purification methods include ultrafiltration, treatment with ion exchange beads, dialysis and the like.

### Cartridge

According to a fourth aspect of the present invention there is provided an ink jet printer cartridge comprising a chamber and an ink according to the third aspect of the present invention wherein said ink is present in the chamber.

### Ink Jet Printing Process

According to a fifth aspect of the present invention there is provided an ink jet printing process for printing an image on a substrate comprising applying an ink according to the third aspect of the present invention to the substrate.

### Substrate

According to a sixth aspect of the present invention there is provided a substrate printed with an ink according to the third aspect of the present invention.

Preferred substrates are papers, e.g. plain or treated papers, which may have an acid, alkaline or neutral character, especially glossy substrates. Examples of commercially available papers are as described in International patent Application No. WO 2007/148035, page 13, line 24 to the end of line 37, which are incorporated herein by reference thereto.

### EXAMPLES

The invention is further illustrated by the following Examples in which all parts and percentages are by weight unless otherwise stated.

### Polymeric Dispersant Synthesis

### 1.1 Preparation of Dispersant Solution 1 (D1)

A copolymerisation composition was prepared by mixing component ii) benzyl methacrylate (15.0 g, 85.1 mmoles), component iii) divinylbenzene (2.7 g, 20.4 mmoles) and component iv) 3-mercaptopropionic acid (2.2 g, 20.4 mmoles). The copolymerisation composition was then dissolved in a liquid mixture of isopropyl alcohol (50.1 g) and dipropylene glycol (30.0 g) to give a 20% w/w solution which was charged into a reactor.

A thermal initiator, Trigonox 21S, (0.20 g) was then added to the reactor contents, and the contents were stirred continuously whilst the temperature was maintained at 85° C. for 4 hours. The reaction was performed using a nitrogen gas atmosphere throughout.

A second charge of thermal initiator, Trigonox 21S (0.20 g), was then added and the polymerisation was continued at a temperature of 85° C. for a further 4 hours, still using a nitrogen gas atmosphere. These steps polymerised the ethylenically unsaturated monomers to prepare the Polymeric Dispersant (D1) in the form of a dilute solution.

The reactor contents were then cooled to a temperature of 25° C., poured into a rotary evaporator flask and evaporated to concentrate the Polymeric Dispersant (D1) to about 40% w/w solids. The molecular weights of the Polymeric Dispersant (D1) as measured by gel permeation chromatography using a DMF solvent and polystyrene standards were Mn 13,357 and Mw 65,479. Thus, step 1.1 resulted in the preparation of Polymeric Dispersant solution (D1).

### 1.2 Preparation of Neutralised Dispersant Solution 1 (ND1)

The Polymeric Dispersant solution (D1) prepared in 1.1 above (50.1 g) was neutralised by the addition of a solution containing potassium hydroxide (0.92 g) and water (86.7 g). This prepared Neutralised dispersant solution (ND1) at a solids content of 15% by weight.

### 2.1 Preparation of Dispersant Solution 2 (D2)

A copolymerisation composition was prepared by mixing component ii) benzyl methacrylate (15.0 g, 85.1 mmoles), component iii) divinylbenzene (4.7 g, 35.8 mmoles) and component iv) 3-mercaptopropionic acid (3.8 g, 35.8 mmoles). The copolymerisation composition was then dissolved in a liquid mixture of isopropyl alcohol (59.2 g) and dipropylene glycol (35.5 g) to give a 20% w/w solution which was charged into a reactor.

A thermal initiator, Trigonox 21S, (0.23 g) was then added to the reactor contents, and the contents were stirred continuously whilst the temperature was maintained at 85° C. for 4 hours. The reaction was performed using a nitrogen gas atmosphere throughout.

A second charge of thermal initiator, Trigonox 21S (0.23 g), was then added and the polymerisation was continued at a temperature of 85° C. for a further 4 hours, still using a nitrogen gas atmosphere. These steps polymerised the ethylenically unsaturated monomers to prepare the Polymeric Dispersant (D2) in the form of a dilute solution.

The reactor contents were then cooled to a temperature of 25° C., poured into a rotary evaporator flask and evaporated to concentrate the Polymeric Dispersant (D2) to about 40% w/w solids. The molecular weights of the Polymeric Dispersant (D2) as measured by gel permeation chromatography using a DMF solvent and polystyrene standards were Mn 11,393 and Mw 28,497. Thus, step 2.1 resulted in the preparation of Polymeric Dispersant solution (D2).

### 2.2 Preparation of Neutralised Dispersant Solution 2 (ND2)

The Polymeric Dispersant solution (D2) prepared in 2.1 above (59.2 g) was neutralised by the addition of a solution containing potassium hydroxide (1.61 g) and water (104.3 g). This prepared Neutralised dispersant solution (ND2) at a solids content of 15% by weight.

### 3.1 Preparation of Dispersant Solution 3 (D3)

A copolymerisation composition was prepared by mixing component ii) benzyl methacrylate (12.0 g, 68.1 mmoles), component iii) divinylbenzene (6.2 g, 47.7 mmoles) and component iv) 3-mercaptopropionic acid (5.1 g, 47.7 mmoles). The copolymerisation composition was then dissolved in a liquid mixture of isopropyl alcohol (58.7 g) and dipropylene glycol (35.2 g) to give a 20% w/w solution which was charged into a reactor.

A thermal initiator, Trigonox 21S, (0.23 g) was then added to the reactor contents, and the contents were stirred continuously whilst the temperature was maintained at 85° C. for 4 hours. The reaction was performed using a nitrogen gas atmosphere throughout.

A second charge of thermal initiator, Trigonox 21S (0.23 g), was then added and the polymerisation was continued at a temperature of 85° C. for a further 4 hours, still using a nitrogen gas atmosphere. These steps polymerised the ethylenically unsaturated monomers to prepare the Polymeric Dispersant (D3) in the form of a dilute solution.

The reactor contents were then cooled to a temperature of 25° C., poured into a rotary evaporator flask and evaporated to concentrate the Polymeric Dispersant (D3) to about 40% w/w solids. The molecular weights of the Polymeric Dispersant (D3) as measured by gel permeation chromatography using a DMF solvent and polystyrene standards were Mn 9,215 and Mw 17,938. Thus, step 3.1 resulted in the preparation of Polymeric Dispersant solution (D3).

### 3.2 Preparation of Neutralised Dispersant Solution 3 (ND3)

The Polymeric Dispersant solution (D3) prepared in 3.1 above (58.7 g) was neutralised by the addition of a solution containing potassium hydroxide (2.14 g) and water (105.5 g). This prepared Neutralised dispersant solution (ND3) at a solids content of 15% by weight.

### 4.1 Preparation of Dispersant Solution (D4)

A copolymerisation composition was prepared by mixing component ii) benzyl methacrylate (7.0 g, 39.7 mmoles), component i) 4-vinylphenyl boronic acid (5.4 g, 36.7 mmoles), component iii) divinylbenzene (3.8 g, 29.0 mmoles) and component iv) 3-mercaptopropionic acid (3.1 g, 29.0 mmoles). The copolymerisation composition was then dissolved in a liquid mixture of isopropyl alcohol (48.7 g) and dipropylene glycol (29.2 g) to give a 20% w/w solution which was charged into a reactor.

A thermal initiator, Trigonox 21S, (0.19 g) was then added to the reactor contents, and the contents were stirred continuously whist the temperature was maintained at 85° C. for 4 hours. The reaction was performed using a nitrogen gas atmosphere throughout.

A second charge of thermal initiator, Trigonox 21S (0.19 g), was then added and the polymerisation was continued at a temperature of 85° C. for a further 4 hours, still using a nitrogen gas atmosphere. These steps polymerised the ethylenically unsaturated monomers to prepare the Polymeric Dispersant (D4) in the form of a dilute solution.

The reactor contents were then cooled to a temperature of 25° C., poured into a rotary evaporator flask and evaporated to concentrate the Polymeric Dispersant (D4) to about 40% w/w solids. The molecular weights of the Polymeric Dispersant (D4) could not be measured as the polymer was not soluble in the GPC eluent. Thus, step 4.1 resulted in the preparation of Polymeric Dispersant solution (D4).

### 4.2 Preparation of Neutralised Dispersant Solution 4 (ND4)

The Polymeric Dispersant solution (D4) prepared in 4.1 above (48.7 g) was neutralised by the addition of a solution containing potassium hydroxide (1.30 g) and water (85.8 g). This prepared Neutralised dispersant solution (ND4) at a solids content of 15% by weight.

### 5.1 Preparation of Comparative Polymeric Dispersant Solution (CD1)

A copolymerisation composition was prepared by mixing component ii) benzyl methacrylate (18.2 g, 103.3 mmoles), component i) methacrylic acid (5.0 g, 58.1 mmoles) and a chain transfer agent butyl 3-mercaptopropionate (0.21 g, 1.3 mmoles). This was a comparative because none of the CTAs used had hydrophilic groups. The copolymerisation composition was then dissolved in a liquid mixture of isopropyl alcohol (59.1 g) and dipropylene glycol (35.5 g) to give a 20% w/w solution which was charged into a reactor.

A thermal initiator, Trigonox 21S, (0.21 g) was then added to the reactor contents, and the contents were stirred continuously whist the temperature was maintained at 85° C. for 4 hours. The reaction was performed using a nitrogen gas atmosphere throughout.

A second charge of thermal initiator, Trigonox 21S (0.21 g), was then added and the polymerisation was continued at a temperature of 85° C. for a further 4 hours, still using a nitrogen gas atmosphere. These steps polymerised the ethylenically unsaturated monomers to prepare the Comparative Polymeric Dispersant (CD1) in the form of a dilute solution.

The reactor contents were then cooled to a temperature of 25° C., poured into a rotary evaporator flask and evaporated to concentrate the Comparative Polymeric Dispersant (CD1) to about 40% w/w solids. The molecular weights of the Comparative Polymeric Dispersant (CD1) as measured by gel permeation chromatography using a DMF solvent and polystyrene standards were Mn 36,378 and Mw 60,860. Thus, step 5.1 resulted in the preparation of Comparative Polymeric Dispersant solution (CD1).

### 5.2 Preparation of Neutralised Comparative Dispersant Solution 1 (NCD1)

The Comparative Polymeric Dispersant solution (CD1) prepared in 5.1 above (59.1 g) was neutralised by the addition of a solution containing potassium hydroxide (2.61 g) and water (107.7 g). This prepared Neutralised Comparative dispersant solution (NCD1) at a solids content of 15% by weight.

### 6. Preparation of Pigment Dispersions

Pigment dispersions PD1 to PD4 and Comparative pigment dispersion CPD1 were prepared from neutralised dispersants ND1 to ND4 and NCD1 using the following general method:

Cyan pigment (TRB 2 from Dainichiseika color and chemicals mfg co ltd) (15 parts) was mixed with neutralised dispersant solution (e.g. ND1) (50 parts) and de-ionized water (35 parts). The mixture was then dispersed to form a pre-dispersion. The pre-dispersion was then placed into a Branson Digital S450D Ultrasonifier fitted with a 1.25 cm tapped horn with a flat tip. The pre-dispersion was cooled using an ice-bath and mechanically treated at 60% amplitude to give a resulting pigment dispersion with an MV average particle size of less than 150 nm as measured by a Nanotrac™ instrument.

### 7. Preparation of Encapsulated Pigment Dispersions

Pigment dispersion (PD1) (98.6 parts) was mixed with Denacol™ EX321 an epoxy cross-linking agent (0.18 g) and 6.18 wt % boric acid aqueous solution (1.23 g) and was stirred at 60° C. for 24 hours to complete the cross-linking reaction. This resulted in encapsulated pigment dispersion (EPD1).

### 8. Inks 1 to 4, 1A and Comparative Ink 1

Inks 1 to 4 (containing PDs1-4), Ink 1A (containing EPD1) and Comparative Ink 1 (containing CPD1) were prepared by rolling a sealed bottle on rollers for a period of 30 minutes, each bottle containing the following ingredients:
i) a pigment dispersion from step (6) or the encapsulated pigment dispersion from step (7) (26.67 parts) along with water (45.83 parts); and
ii) an organic liquid mixture (27.5 parts) comprising 2-pyrrolidone (3 parts), glycerol (15 parts), 1,2-hexane diol (4 parts), ethylene glycol (5 parts) and Surfynol™ 465 (0.5 parts obtained from Air Products).

### 9. Ink Jet Printing and Print Testing

Example Inks 1 to 4, 1A and Comparative Ink 1 were applied to Canon GF500 plain ink jet paper using an IJ printer and allowed to dry before the reflectance optical density (ROD) was measured using a Gretag Macbeth Spectrolino spectophotometer.

### 10. Print Results

Table 1 summarises the reflectance optical density (ROD) for the C (cyan) pigment dispersions.

TABLE 1

| Ink | Dispersion used | ROD |
|---|---|---|
| Comparative Ink 1 | CPD1 | 1.14 |
| Ink 1 | PD1 | 1.21 |
| Ink 1A | EPD1 | 1.25 |
| Ink 2 | PD2 | 1.18 |
| Ink 3 | PD3 | 1.16 |
| Ink 4 | PD4 | 1.21 |

Similar results were found on other papers.

It was readily seen that the inks obtained from the process according to the first aspect of the present invention had significantly higher ROD as compared to analogous pigment dispersions wherein the dispersant is obtained from a copolymerisation composition in which none of the CTAs has hydrophilic groups.

### Further Inks

The further inks described in Tables I and II may be prepared wherein the Pigment Dispersions PD1 to PD4 and EPD1 are as defined above and the ink additives are as defined below. Numbers quoted in the second column onwards refer to the number of parts of the relevant ingredient and all parts are by weight. The inks may be applied to paper by thermal, piezo or Memjet ink jet printing.

The following abbreviations are used in Table I and II:

PG=propylene glycol

DEG=diethylene glycol

NMP=N-methyl pyrrolidone

DMK=dimethylketone

IPA=isopropanol

MEOH=methanol

2P=2-pyrrolidone

MIBK=methylisobutyl ketone

P12=propane-1,2-diol

BDL=butane-2,3-diol

Surf=Surfynol™ 465 from Airproducts

PHO=Na₂HPO₄

TBT=tertiary butanol

TDG=thiodiglycol

GLY=Glycerol

nBDPG=mono-n-butyl ether of dipropylene glycol

nBDEG=mono-n-butyl ether of diethylene glycol

nBTEG=mono-n-butyl ether of triethylene glycol

PD=Pigment Dispersion

TABLE I

| PD | PD Amount | Water | PG | DEG | NMP | DMK | NaOH | Na Stearate | IPA | MEOH | 2P | MIBK | GLY | nBDPG |
|---|---|---|---|---|---|---|---|---|---|---|---|---|---|---|
| 1 | 30 | 50 | 5 | | 6 | 3 | | | | | 5 | | 1 | |
| 1 | 30 | 59.8 | | 5 | 5 | | 0.2 | | | | | | | |
| 2 | 40 | 45 | 3 | | 3 | 3 | | | | 5 | 1 | | | |
| 2 | 40 | 51 | | 8 | | | | | | | | 1 | | |
| 2 | 40 | 45.8 | 5 | | | | | 0.2 | 4 | | | 5 | | |
| 2 | 40 | 41 | | | 9 | | 0.5 | 0.5 | | | 9 | | | |
| 3 | 40 | 10 | 4 | 15 | 3 | 3 | | | 6 | 10 | 5 | 4 | | |
| 3 | 40 | 30 | | 20 | | | | | 9 | | | | | 1 |
| 3 | 50 | 25 | 5 | 4 | | 5 | | | | 6 | | 5 | | |
| 3 | 50 | 29.7 | 3 | 5 | 2 | 10 | | 0.3 | | | | | | |
| 4 | 50 | 15 | | 5 | 4 | 6 | | | 5 | 4 | 6 | 5 | | |
| 4 | 50 | 46 | | | | | | | | 4 | | | | |
| 4 | 40 | 50 | 5 | | | | | | 5 | | | | | |
| 4 | 40 | 40 | 2 | 6 | 2 | 5 | | | 1 | | 4 | | | |
| 1 | 40 | 40 | | 5 | | | | | | | 15 | | | |
| 2 | 40 | 44 | | | 11 | | | | | | 5 | | | |
| 3 | 50 | 30 | 2 | | | 10 | | | | 2 | | 6 | | |
| 4 | 50 | 39.7 | | | | 7 | 0.3 | | 3 | | | | | |
| 1 | 40 | 29 | 2 | 20 | 2 | 1 | | | | | 3 | 3 | | |
| 1 | 40 | 51 | | | 4 | | | | | | 5 | | | |
| 1 | 40 | 40 | | | | | | | | | | | 20 | |
| 1 | 40 | 40 | | | | | | | | | | | | 20 |

TABLE II

| EPD | PD Amount | Water | PG | DEG | NMP | Surf | TBT | TDG | BDL | PHO | 2P | PI2 | nBDEG | nBTEG |
|---|---|---|---|---|---|---|---|---|---|---|---|---|---|---|
| 1 | 30 | 49.8 | 15 | | | 0.2 | | | | | 5 | | | |
| 1 | 30 | 58.8 | | 5 | | | | | | 1.2 | | 5 | | |
| 1 | 40 | 44.65 | 5 | 5 | | 0.1 | 4 | 0.2 | | | | | | 1 |
| 1 | 40 | 49.88 | | 6 | 4 | 5 | | | | 0.12 | | | | |
| 1 | 40 | 41.7 | 4 | 8 | | | | | | | | 6 | | |
| 1 | 40 | 44.8 | | 10 | | 0.3 | | | 5 | 0.2 | | | | |
| 1 | 50 | 39.7 | | 5 | 5 | | | 0.3 | | | | | | |
| 1 | 50 | 20 | | 10 | 4 | | | | 1 | | 4 | 11 | | |
| 1 | 40 | 35 | 4 | 10 | 3 | | | | 2 | | 6 | | | |
| 1 | 40 | 51 | | | 6 | | | | | | 3 | | | |
| 1 | 40 | 35.05 | | 9 | 7 | | 2 | | | 0.95 | 5 | | 1 | |
| 1 | 40 | 38 | 5 | 11 | | | | | | | 6 | | | |
| 1 | 50 | 36 | | | 7 | | | | | | 7 | | | |
| 1 | 50 | 24.5 | 5 | 5 | 4.1 | | 0.2 | 0.1 | 5 | 0.1 | 5 | | | |
| 1 | 40 | 50 | | 10 | | 1 | | | | | | | | |
| 1 | 40 | 50 | | | | | | 10 | | | | | | |
| 1 | 30 | 48 | | | 5 | | | 12 | | | 5 | | | |
| 1 | 30 | 40 | 2 | | 8 | | | 15 | | | 5 | | | |
| 1 | 40 | 40 | | | | | | 8 | | | 12 | | | |
| 1 | 40 | 40 | | 10 | | | | | | | | | 1 | |
| 1 | 40 | 40 | | | | | | | | | 10 | | 0 | 10 |

1-21. (canceled)

22. A process for preparing a dispersion of a particulate solid comprising:
dispersing a particulate solid with a dispersant and a liquid medium,
wherein the dispersant is a random copolymer obtained from the copolymerisation of a composition comprising:
i) optionally one or more monoethylenically unsaturated hydrophilic monomers,
ii) one or more monoethylenically unsaturated hydrophobic monomers,
iii) one or more di- and/or higher-ethylenically unsaturated monomers, and
iv) one or more chain transfer agents wherein at least one of the chain transfer agents has one or more hydrophilic anionic groups;
wherein the dispersion step is effected by a mechanical treatment which reduces the particle size of the particulate solid; and
the ratio of the total hydrophilic groups in all of the one or more monoethylenically unsaturated hydrophilic monomers of component i) expressed in moles to the total amount of hydrophilic anionic groups in all the chain transfer agents of component iv) expressed in moles is less than 5:1.

23. A process according to claim 22 wherein the ratio of the total hydrophilic anionic groups in all of the one or more monoethylenically unsaturated hydrophilic monomers of component i) expressed in moles to the total amount of hydrophilic anionic groups in all the chain transfer agents of component iv) expressed in moles is less than 3:1.

24. A process according to claim 22 wherein at least 20 mol % of the total hydrophilic anionic groups present in the dispersant are attached to a chain transfer agent group, said chain transfer group being attached to the dispersant.

25. A process according to claim 22 wherein component i), when present, comprises (meth)acrylic acid.

26. A process according to claim 22 wherein the copolymerisation composition contains no component i) and the resulting dispersant contains only hydrophilic anionic groups which are attached to the dispersant via a chain transfer agent group.

27. A process according to claim 22 wherein component iii) is present at from 10 to 50 mol % and mol % is based on the total number of moles of all the monomers present in components i) to iii).

28. A process according to claim 22 wherein component iii) contains no higher ethylenically unsaturated monomers.

29. A process according to claim 22 wherein component iii) comprises divinyl benzene and/or diurethane di(meth)acrylate.

30. A process according to claim 22 wherein component ii) comprises benzyl (meth)acrylate.

31. A process according to claim 22 wherein the dispersant has an acid value of 50 to 200 mg KOH/g of dispersant.

32. A process according to claim 22 wherein the dispersant has a calculated Log P of from 1 to 4.

33. A process according to claim 22 wherein the dispersant has no hydrophilic non-ionic groups.

34. A process according to claim 22 wherein the only hydrophilic groups present in the dispersant are carboxylic acid groups.

35. A process according to claim 22 wherein the particulate solid is carbon black or an organic pigment.

36. A process according to claim 22 wherein the copolymerisation composition comprises:
i) 0 to 45 mol % of monoethylenically unsaturated hydrophilic monomer(s);
ii) 50 to 95 mol % of monoethylenically unsaturated hydrophobic monomer(s),
iii) 5 to 50 mol % of di- and/or higher ethylenically unsaturated monomer(s); wherein mol % is based on the total number of moles of all the monomers i) to iii), the total mol % of monomers i) to iii) is 100%; and
iv) 0.7(n−1) to 3(n−1) moles of total chain transfer agent(s) per mole of di- or higher-ethylenically unsaturated monomer(s), where n is the number of ethylenically unsaturated groups in the di- or higher-ethylenically unsaturated monomer(s); and
v) 0.1 to 15 wt % of free radical initiator(s) based on the sum of the weights of components i) to iii).

37. A process according to claim 22 which further comprises the step of cross-linking the dispersant with a cross-linking agent in the presence of the particulate solid and the liquid medium, thereby encapsulating the particulate solid within the cross-linked dispersant.

38. An encapsulated particulate solid obtained by a process according to claim 37.

39. An ink comprising an encapsulated particulate solid according to claim 38 and a liquid medium.

40. An ink jet printer cartridge comprising a chamber and an ink wherein the ink is present in the chamber and the ink is according to claim 39.

41. An ink jet printing process for printing an image on a substrate comprising applying an ink according to claim 39 to the substrate.
